(19) United States
(12) Patent Application Publication
(10) Pub. No.: US 2026/0137101 A1
(43) Pub. Date: May 21, 2026

(54) BINDER COMPOSITION FOR MEAT SUBSTITUTE

(71) Applicant: ROQUETTE FRERES, Lestrem (FR)

(72) Inventors: Sayaka HORI-MINOURA, TOKYO (JP); Goichi ITO, Tokyo (JP); Florian SARRAZIN, FOUQUEREUIL (FR)

(21) Appl. No.: 19/119,325

(22) PCT Filed: Oct. 6, 2023
(86) PCT No.: PCT/EP2023/025424

§ 371 Date: Apr. 8, 2025

(30) Foreign Application Priority Data
Oct. 10, 2022 (FR) FR2210364

(51) Int. Cl. A23J 3/22; A21D 2/18; A21D 2/26; A23J 3/14; A23J 3/30; A23L 29/212

(52) U.S. Cl. CPC A23J 3/227; A21D 2/186; A21D 2/266; A23J 3/14; A23J 3/30; A23L 29/212

(57) ABSTRACT

The invention relates to a binder compound, a mixture of vegetable proteins and pea starch, to a method for obtaining same and to the use thereof in industry, in particular in the field of food, more particularly in the production of meat substitutes.

### TECHNICAL FIELD

The invention relates to the field of food, meat substitutes and in particular so-called binder compounds used in these applications.

### PRIOR ART

Meat and meat by-products are made mainly from muscle tissue harvested post-mortem from animals bred for the purpose of this production.

For many years, mankind has been developing alternatives to meat aimed at limiting or even eliminating the use of these muscle tissues, by developing a new class of food products called meat substitutes.

These meat substitutes are made up of several ingredients, mainly textured vegetable proteins (aiming to reproduce the fibrousness of meat), colorants and flavors (aiming to reproduce the taste and the smell of meat), lipids, and many other compounds.

In order to make the whole mixture of these compounds cohesive, it is essential to use what is commonly known in the field as a binder. The choice of this binder is crucial as it must make the resulting substitute cohesive without hardening it. It must also be easy to use from an industrial point of view, participate with all the other compounds to produce a texture as close as possible to meat, be neutral from an organoleptic point of view and not be toxic.

Historically, the food industry has developed the use and continues to use egg albumin, more commonly known as “egg white”. While this solution is functional, it is however regrettable that some customers wishing to avoid all products of animal origin use egg albumin in meat substitutes.

The industry has since developed the alternative use of methyl cellulose. Methyl cellulose is a cellulose derivative in which methyl groups (—CH3) replace the hydroxyls naturally present in the C-2, C-3 and/or C-6 positions of anhydro-D-glucose cellulose units. Methyl cellulose is produced by an alkaline treatment followed by a chemical reaction with a methylating agent such as chloromethane, iodomethane or dimethyl sulfate. While this compound also works perfectly, it is understandable that the use of an unnatural compound, obtained via chemical reactions, may not satisfy some customers.

Other solutions also exist such as the use of vegetable fibers and flours, emulsified with lipids as disclosed in patent application WO2022/112315. However, this solution remains complex to implement.

It is always important for the food industry to have a binder for meat substitutes that is as easy to use as possible, inexpensive and made up of a limited number of compounds.

### GENERAL DESCRIPTION

The invention is embodied primarily as a composition comprising a mixture of vegetable proteins, preferentially leguminous plants, and pea starch characterized in that the ratio by weight of leguminous plant proteins to pea starch is from 1:1.5 to 1:4, preferentially from 1:1.5 to 1:2, even more preferentially from 1:1.5 to 1:1.7.

Preferably, the starch content of the composition, expressed as a percentage of total solids, is between 60% and 80%, preferentially between 60% and 67%, even more preferentially between 60% and 63%.

Preferably, the composition according to the invention consists of a mixture of vegetable proteins, preferentially leguminous plants, and pea starch, characterized in that the ratio by weight of leguminous plant proteins to pea starch is from 1:1.5 to 1:4, preferentially from 1:1.5 to 1:2, even more preferentially from 1:1.5 to 1:1.7.

Preferably, the mixture of vegetable proteins, preferentially leguminous plants, and pea starch also contains potato starch in a weight ratio of potato starch to pea starch ranging from 1.5 to 2.0, preferentially from 1.6 to 1.9, preferentially from 1.7 to 1.9.

The invention is also embodied as the method for obtaining a composition according to the invention characterized in that it comprises the following steps:
a. Providing vegetable proteins and pea starch
b. Optionally providing potato starch
c. Mixing compounds obtained in step a) and optionally in step b)
d. Optionally, final shaping of the mixture obtained in step c)

Finally, the invention is embodied as the use of the composition according to the invention or obtained according to the method of the invention for use in the industrial fields in particular food, nutraceuticals and pharmaceuticals.

### DETAILED DESCRIPTION

The invention is embodied primarily as a composition comprising a mixture of vegetable proteins, preferentially leguminous plants, and pea starch characterized in that the ratio by weight of leguminous plant proteins to pea starch is from 1:1.5 to 1:4, preferentially from 1:1.5 to 1:2, even more preferentially from 1:1.5 to 1:1.7.

Preferably, the starch content of the composition, expressed as a percentage of total solids, is between 60% and 80%, preferentially between 60% and 67%, even more preferentially between 60% and 63%.

To specify this mode, the starch content in the composition, expressed as a percentage of total solids, may be 60%, 61%, 62%, 63%, 64%, 65%, 66%, 67%, 68%, 69%, 70%, 71%, 72%, 73%, 74%, 75%, 76%, 77%, 78%, 79% or 80%, as well as all the ranges formed by these values.

Preferably, the composition according to the invention consists of a mixture of vegetable proteins, preferentially leguminous plants, and pea starch, characterized in that the ratio by weight of leguminous plant proteins to pea starch is from 1:1.5 to 1:4, preferentially from 1:1.5 to 1:2, even more preferentially from 1:1.5 to 1:1.7.

The term “vegetable proteins” is to be understood as any extract, any composition containing proteins from plant sources. For the sake of clarification, proteins derived from eggs, milk or animals are excluded from this designation, while proteins derived from plants or algae are included.

The term “leguminous plants” is used herein to refer to the family of dicotyledonous plants belonging to the family Fabaceae or Leguminosae belonging to the order Fabales. This is one of the largest flowering plant families, third after Orchidaceae and Asteraceae in terms of number of species. It contains approximately 765 genera, bringing together more than 19,500 species. Several leguminous plants are important crop plants, including soybean, beans, peas, faba beans, chickpeas, peanuts, cultivated lentils, cultivated alfalfa, various clovers, broad beans, carob and licorice. This definition notably includes all the plants described in any one of the tables contained in the article by R. HOOVER et al. entitled “Composition, structure, functionality and chemical modification of legume starches: a review” (Can. J. Physiol. Pharmacol. 1991, 69 pp. 79-92).

Preferably, vegetable proteins, preferentially leguminous plants, are proteins from peas, faba beans, or a mixture thereof. Even more preferably, the vegetable protein is a pea protein.

The term “pea” is considered here in its broadest accepted use and includes in particular all the varieties of “smooth pea” and “wrinkled pea” and all the mutant varieties of “smooth pea” and “wrinkled pea”, regardless of the uses for which said varieties are usually intended (human food, animal feed and/or other uses).

The term “pea” in the present application includes pea varieties belonging to the Pisum genus and more particularly to the species sativum and aestivum. Said mutant varieties are in particular those named “r mutants”, “rb mutants”, “rug 3 mutants”, “rug 4 mutants”, “rug 5 mutants” and “lam mutants” as described in the article by C-L HEYDLEY et al., entitled “Developing novel pea starches” Proceedings of the Symposium of the Industrial Biochemistry and Biotechnology Group of the Biochemical Society, 1996, pages 77-87.

“Faba bean” is understood as the group of annual plants of the species Vicia faba, belonging to the group of leguminous plants of the family Fabaceae, subfamily Faboideae, tribe Fabeae. A distinction is made between Minor and Major varieties. In the present invention, wild-type varieties and those obtained by genetic engineering or varietal selection are all excellent sources.

If the leguminous plant proteins, in particular derived from peas or faba beans, are particularly adapted to the design of the invention, it is nevertheless possible to achieve the latter with other sources of vegetable proteins such as oat, mung bean, potato, corn, sunflower, hemp or even chickpea protein. The person skilled in the art will know how to make any necessary adjustments.

Preferably, the protein content of vegetable proteins, in particular leguminous plants, and more particularly derived from peas or faba beans, used in the composition according to the invention is advantageously between 60% and 90%, preferentially between 70% and 88%, even more preferentially between 80% and 88% by weight to the total solids. Any method well known to the person skilled in the art can be used to analyze this protein content. Preferably, the total nitrogen amount, typically according to the Kjeldahl method, will be assayed and this content will be multiplied by the coefficient 6.25. This method is well known to the person skilled in the art and is commonly used to analyze the protein content of vegetable protein compositions.

Preferably, the leguminous plant proteins, in particular derived from pea or faba bean, used in the composition according to the invention are native, which is to be understood as not having been subjected to chemical or enzymatic hydrolysis. However, a slight hydrolysis may be acceptable, and may even lead to an organoleptic improvement. The degree of such hydrolysis will be between 0% and 15%, preferentially between 2% and 13%, preferentially between 3% and 10%, even more preferentially between 4% and 8%.

In the present application, “starch” is understood as a mixture of two homopolymers, amylose and amylopectin, composed of D-glucose units bonded to one another by α-(1-4) and α-(1-6) linkages which are the source of branching in the structure of the molecule.

These two homopolymers differ in terms of the degree of branching thereof, and the degree of polymerization thereof. Amylose is slightly branched with short branches and has a molecular weight between 10,000 and 1,000,000 daltons. The molecule is formed of 600 to 1,000 glucose molecules. Amylopectin is a branched molecule with long branches every 24 to 30 glucose units, via α-(1-6) linkages. The molecular weight thereof ranges from 1,000,000 to 100,000,000 daltons and the degree of branching thereof is about 5%. The total chain can include 10,000 to 100,000 glucose units. The ratio of amylose to amylopectin depends on the botanical source of the starch.

Starch is stored in storage organs and tissues in a granular state, that is in the form of semi-crystalline granules. This semi-crystalline state is essentially due to the amylopectin macromolecules.

In the native state, starch grains have a degree of crystallinity which ranges from 15 to 45% by weight which depends substantially on the botanical origin and on the method used for their extraction. Granular starch placed under polarized light thus has, in microscopy, a characteristic black cross referred to as “Maltese cross”. This phenomenon of positive birefringence is due to the semi-crystalline organization of the granules: since the average orientation of the polymer chains is radial.

For a more detailed description of granular starch, reference may be made to chapter II, entitled “Structure et morphologie du grain d'amidon” [“Structure and morphology of the starch grain” ] by S. Perez, in the work “Initiation à la chimie et à la physico-chimie macromoléculaires” [“Introduction to macromolecule chemistry and physical chemistry”], first edition, 2000, volume 13, pages 41 to 86, Groupe Français d'Etudes et d'Applications des Polymères [French Polymer Group].

Dry starch contains a water content which ranges from 12 to 20% by weight depending on the botanical origin. This water content obviously depends on the residual moisture of the medium (for a water activity (aw)=1, the starch may fix up to 0.5 g of water per gram of starch).

Heating, with an excess of water, a starch suspension to temperatures of greater than 50° C. leads to irreversible swelling of the grains and leads to the dispersion thereof, then the dissolution thereof.

It is these properties in particular which give starch its technological properties of interest.

For a given temperature range, referred to as “gelatinization range”, the starch grain will very quickly swell and lose its semi-crystalline structure (loss of birefringence).

All the grains will be as swollen as possible over a temperature range of the order of 5 to 10° C. A paste is obtained composed of swollen grains which constitute the dispersed phase, and molecules (mainly amylose) which thicken the aqueous continuous phase.

The rheological properties of the paste depend on the relative proportion of these two phases and on the swelling volume of the grains. The gelatinization range is variable depending on the botanical origin of the starch.

The maximum viscosity is obtained when the starch paste contains a large number of highly swollen grains. When heating is continued, the grains will burst and the material will disperse into the medium, however dissolution will only occur for temperatures greater than 100° C.

Amylose-lipid complexes have delayed swelling because the combination prevents the interaction of the amylose with the water molecules, and temperatures of greater than 90° C. are necessary in order to obtain the total swelling of the grains (amylomaize being complexed to the lipids).

The disappearance of the grains and the dissolution of the macromolecules leads to a reduction in the viscosity.

Lowering the temperature (by cooling) of the starch paste causes insolubilization of the macromolecules and phase separation due to the incompatibility between amylose and amylopectin, then crystallization of these macromolecules is observed.

This phenomenon is known by the name retrogradation.

When a paste contains amylose, it is this first molecule which will undergo retrogradation.

It will consist in the formation of a double helix and the combination of these double helices to form “crystals” (type B) which will give rise to a three-dimensional network via junction zones.

This network is formed very quickly, in a few hours. During the development of this network, the association of the double helices with one another via hydrogen bonds displaces the water molecules associated with the helices and causes significant syneresis.

Preferably, the starch used according to the invention is a leguminous plant starch and more particularly pea starch. Indeed, pea seeds are known for their high starch content (between 55 and 70% by weight of dry matter) and for their low glycemic index (Ratnayake et al., 2002, Pea starch, composition, structure and properties—A review, in Starch/Stärke, 54, 217-234).

“Leguminous plant starch” is understood as any composition extracted, by any means, from a leguminous plant and notably from a papilionaceae, the starch content of which is greater than 40%, preferably greater than 50% and even more preferentially greater than 75%, these percentages being expressed as dry weight relative to the dry weight of said composition. Advantageously, this starch content is greater than 90% by weight (dry/dry). It may in particular be greater than 95% by weight, including greater than 98% by weight. Thus, the amylose content of the starch is comprised between 25% and 45%, preferably of the order of 35% by total weight of starch.

“Native” starch is understood as a starch which has not undergone any chemical or physical modification.

“Pre-gelatinized” or “pre-gel” starch is understood as a starch that has been cooked and then dried in a starch factory on a drying drum or in an extruder, rendering the starch soluble in cold water.

The pre-gelatinization of starch is an operation well known to the person skilled in the art wherein cooking is carried out at a temperature below the gelatinization temperature of the starch.

Pre-gelatinized starches can be obtained by hydrothermal gelatinization of native starches or modified starches, notably by steam cooking, jet-cooking, drum cooking or kneading cooking.

Such starches generally have a solubility in deionized water at 20° C. greater than 5% by weight and more generally comprised between 10% and 100%, and a degree of starch crystallinity less than 15% (in A_RX diffraction intensity), generally less than 5%, and most commonly less than 1%, or even zero.

To measure the solubility: place in a 200 ml beaker, 5 g of product in 100 ml of distilled water. Stir, at room temperature, for 15 minutes. Centrifuge for 10 minutes at 4,000 rpm. In the absence of deposition, there is total solubility.

The degree of crystallinity is measured by X-ray diffraction, as described in U.S. Pat. No. 5,362,777 (column 9, lines 8 to 24).

As an example, the products manufactured and marketed by the Applicant under the PREGEFLO® trademark can be cited, and more particularly as used in the present example:
PREGEFLO® L100 G, prepared from pea starch of large particle size; that is, having, according to the German standard DIN 66145:1976-04, an “n” value comprised between 1.6 and 2, preferentially of the order of 1.8 and a “d′” value comprised between 900 and 1000 μm, preferentially of the order of 900 μm.
PREGEFLO® L100 F, prepared from pea starch of fine particle size, obtained by grinding PREGEFLO® L100 G in such a way as to present, according to the German standard DIN 66145:1976-04, an “n” value comprised between 1.2 and 1.8, and a “d′” value comprised between 100 and 120 μm.
PREGEFLO® P100 G, prepared from potato starch, of the same particle size as PREGEFLO® L100 G used in the present invention.

According to the invention, “modified starch” is understood as any starch that has undergone chemical and/or enzymatic modification. Preferably any starch that has been chemically treated to impart specific properties, such as acetylated, oxidized, hydroxypropylated or phosphate cross-linked starches. Even more preferably, the starch is cross-linked.

Preferably, pea starch is native, pregelatinized or cross-linked.

To specify the ratio of leguminous plant protein to pea starch, this could be 1:1.5; 1:1.6; 1:1.7; 1:1.8; 1:1.9 1:2; 1:2.1; 1:2.2; 1:2.3; 1:2.4; 1:2.5; 1:2.6; 1:2.7; 1:2.8; 1:2.9; 1:3; 1:3.1; 1:3.2; 1:3.4; 1:3.5; 1:3.6; 1:3.7; 1:3.8; 1:3.9; or 1:4.

Preferably, the mixture of vegetable proteins, preferentially leguminous plants, and pea starch also contains potato starch in a weight ratio of potato starch to pea starch ranging from 1.5 to 2.0, preferentially from 1.6 to 1.9, preferentially from 1.7 to 1.9.

According to the invention, the term “potato” is understood as tubers produced by the species Solanum tuberosum, belonging to the Solanaceae family. The starch produced by potatoes is commonly known as “potato starch”.

The potato starch according to the invention is substantially or exclusively native. It is possible to substitute between 10% and 30%, preferentially 15% and 25%, preferentially 20% of native potato starch with pregelatinized potato starch.

Preferably, the solids content of the composition according to the invention varies from 90% to 100%, preferentially from 92% to 98%, preferentially from 94% to 99%, even more preferentially from 95% to 98% by weight with respect to the total weight of the composition.

Preferentially, other compounds can be added such as for example natural stabilizers, colorants and flavorings.

The invention is also embodied as the method for obtaining a composition described in the preceding paragraph characterized in that it comprises the following steps:
a. Providing vegetable proteins and pea starch
b. Optionally, providing potato starch
c. Mixing compounds obtained in step a) and optionally in step b)
d. Optionally, final shaping of the mixture obtained in step c)

Preferably, the protein and starch powders are provided separately in powder form in step a), optionally potato starch is also provided in powder form in step b), and then the powders are mixed in dry form in step c). After mixing, it is also possible to add an aqueous solvent, apply stirring to homogenize, then finally dry in step d). The mixtures obtained are then stored and incorporated into the final recipe.

The powders used in step a) are not simply vegetable, leguminous plant or pea flour. Indeed, as will be shown in the example section, vegetable seed flour, in particular pea flour, does not achieve the performance levels according to the composition according to the invention.

Alternatively, the protein and starch powders are provided separately in liquid form in step a), optionally potato starch is also provided in powder or liquid form in step b), and then the assembly is mixed in step c). After mixing, it is also possible to dry in step d), although the mixture can be used directly without a drying step.

The optional final shaping step d) may involve sterilization, heating, drying, drum or bag packaging, for example.

Preferably, in the context of preparing a meat substitute, the composition obtained in step c) or in step d) can be added directly with other ingredients required to produce the desired meat substitute. In other words, the binder alternative according to the invention can be used directly in combination with the other ingredients in order to produce the meat substitute.

These ingredients are for example, but are not limited to, proteins such as isolates, concentrates and/or textured proteins, lipids, colorants and salts.

Finally, the invention is embodied as the use of the composition according to the invention or obtained according to the method of the invention in industrial fields, in particular in the human food or animal feed, nutraceutical and pharmaceutical industries.

The invention will be of particular interest in the field of manufacturing sauces, soups, meat substitutes or fish substitutes.

A particular application relates to the use of the composition according to the invention to manufacture meat substitutes, notably ground meat, but also to manufacture bolognese sauce containing a meat substitute, steak substitute for hamburger, meat substitute for pitacos, or “chili sin came”.

In pizzas, the composition according to the invention will be of particular interest for being sprinkled on top of said pizza (as a “topping”).

The human food and animal feed industries include the confectionery industry (for example chocolate, caramel, jelly beans), the bakery industry (for example bread, buns, muffins), the beverage industry (for example high-protein drinks, powdered drinks for reconstitution), and the industry producing substitutes wherein all or part of the animal proteins are replaced by vegetable proteins, notably the meat substitutes or fish substitutes industry (for example sausages, steak hachés, fish nuggets, chicken nuggets), the sauces industry (for example bolognese, mayonnaise), the dairy alternatives industry (for example cheese, vegan cheese, plant-based milkshake),

More preferably, the present invention relates to the use of the composition according to the invention in the field of baking.

The invention will be of particular interest in order to produce inclusions in bakery products such as muffins, cookies, cakes, bagels, pizza dough, breads and breakfast cereals.

The term “inclusions” is understood as particles (herein the composition according to the invention) mixed with a dough before it is cooked. After this step, the composition according to the invention is trapped in the final product (hence the term “inclusion”) and provides both its protein content as well as crunchiness when consumed.

The invention will be of particular interest in order to produce inclusions in confectionery products such as “fat fillings”, chocolates, so as to also provide protein retention as well as crunchiness.

The invention will be of particular interest in order to produce inclusions in products that are alternatives to dairy products such as substitutes for cheese, yogurt, ice cream or beverages.

The invention will be better understood upon reading the following non-limiting examples.

### EXAMPLES

The compounds used in the following examples are:
NUTRALYS® F85F (pea protein isolate produced by Roquette, protein content 84% on solids, degree of hydrolysis with the o-phthaldialdehyde method, better known as the OPA method, 4.5%)
NUTRALYS® S85plus (pea protein isolate produced by Roquette, protein content 86% on solids, degree of OPA hydrolysis 7%)
Pea Starch N-735 (native pea starch produced by Roquette)
PREGEFLO L100G (native pregelatinized starch derived from pea produced by Roquette)

### Example 1: Impact of the Protein/Starch Ratio on the Performance of the Binder According to the Invention for Use as an Alternative to Egg Albumin and/or to Methyl Cellulose

Several mixtures are produced combining native pea starch Pea Starch N-735, pea protein isolate Nutralys® F85F and mains drinking water.

For each ratio tested, a minimum of 3 mixtures having different protein contents are produced.

The solutions thus obtained are gelled using the following protocol:
The ingredients are introduced into the tank of an RVA (“Rapid Viscosity Analyzer”) viscometer
In order to produce the gel, the RVA is started with the following program:

TABLE 1

| Time (min:s) | Function | Value | |
|---|---|---|---|
| 00:00 | Temperature | 35° | C. |
| 00:00 | Speed | 960 | rpm |
| 00:10 | Speed | 160 | rpm |
| 01:00 | Temperature | 35° | C. |
| 09:00 | Temperature | 95° | C. |
| 15:00 | Temperature | 95° | C. |
| 23:00 | Temperature | 35° | C. |

| | |
|---|---|
| 33:00 | End |

Their firmness is analyzed using the following protocol:
18 g of gel is extracted and inserted into a metal capsule
The capsule is placed in a TA Shimadzu EZ-SX texturometer with a cylinder-like probe, an analysis speed of 1 mm/sec and an analysis distance of 10 mm. The measurement is performed twice

Table 2 below summarizes the different gels produced and the firmness values obtained:

TABLE 2

| Starch/protein ratio (%) | | 1:1 | | | 1:1.25 | | | 1:1.5 | | |
|---|---|---|---|---|---|---|---|---|---|---|
| Gel protein concentration (%) | | 5.0% | 7.5% | 10.0% | 5.0% | 7.5% | 10.0% | 5.0% | 7.5% | 10.0% |
| Pea protein isolate | NUTRALYS ® | 1.4 | 2.1 | 2.8 | 1.4 | 2.1 | 2.8 | 1.4 | 2.1 | 2.8 |
| | F85F | | | | | | | | | |
| Pea starch | Pea Starch N-735 | 1.4 | 2.1 | 2.8 | 1.7 | 2.6 | 3.5 | 2.1 | 3.1 | 4.2 |
| Drinking water | — | 25.1 | 23.4 | 22.3 | 24.7 | 23.2 | 21.6 | 24.4 | 22.6 | 20.9 |

| | | |
|---|---|---|
| Table salt | NaCl | 0.1 |

| | | | | | | | | | |
|---|---|---|---|---|---|---|---|---|---|
| Average firmness (2 values, in N) | 0.10 | 1.03 | 3.65 | 0.24 | 1.84 | 6.99 | 0.83 | 5.43 | 11.31 |

| Starch/protein ratio (%) | | 1:2 | | | |
|---|---|---|---|---|---|
| Gel protein concentration (%) | | 2.5% | 4.0% | 5.0% | 7.5% |
| Pea protein isolate | NUTRALYS ® | 0.7 | 1.1 | 1.4 | 2.1 |
| | F85F | | | | |
| Pea starch | Pea Starch N-735 | 1.4 | 2.2 | 2.8 | 4.2 |
| Drinking water | — | 25.8 | 24.5 | 23.7 | 21.6 |

| | | |
|---|---|---|
| Table salt | NaCl | 0.1 |

| | | | | |
|---|---|---|---|---|
| Average firmness (2 values, in N) | 0.07 | 0.76 | 2.12 | 9.67 |

| Starch/protein ratio (%) | | 1:3 | | | 1:4 | | | 1:5 | | |
|---|---|---|---|---|---|---|---|---|---|---|
| Gel protein concentration (%) | | 2.5% | 3.0% | 4.0% | 1.3% | 2.5% | 4.0% | 1.3% | 2.5% | 4.0% |
| Pea protein isolate | NUTRALYS ® | 0.7 | 0.8 | 1.1 | 0.3 | 0.7 | 1.1 | 0.3 | 0.7 | 0.8 |
| | F85F | | | | | | | | | |
| Pea starch | Pea Starch N-735 | 2.1 | 2.5 | 3.4 | 1.4 | 2.8 | 4.5 | 1.7 | 3.5 | 4.2 |
| Drinking water | — | 25.1 | 24.5 | 23.4 | 26.1 | 24.4 | 22.3 | 25.8 | 23.7 | 22.8 |

| | | |
|---|---|---|
| Table salt | NaCl | 0.1 |

| | | | | | | | | | |
|---|---|---|---|---|---|---|---|---|---|
| Average firmness (2 values, in N) | 0.45 | 1.20 | 2.80 | 0.06 | 1.64 | 6.39 | 0.12 | 3.19 | 5.03 |

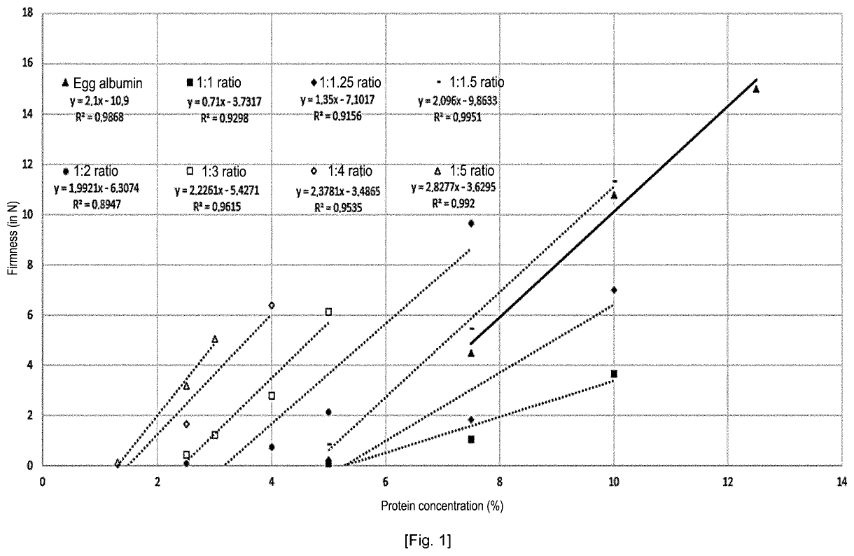

Several lines can be drawn showing the firmness of the gel based on the gel protein concentration, for each starch/protein ratio (see FIG. 1). Finally, the slope of each line is calculated by linear regression.

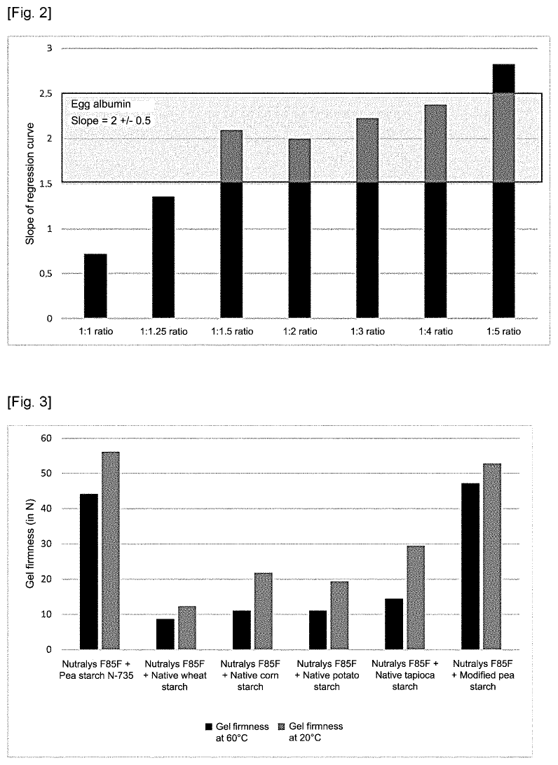

FIG. 2 shows the evolution of this slope based on the pea starch/protein ratio and in comparison with egg albumin which is one of the references. Clearly, only ratios between 1:1.5 and 1:4 give a slope similar to that of egg albumin.

### Example 1 Bis: Impact of Using Yellow Pea Flour Having a Protein/Starch Ratio According to the Invention on Binder Performance as an Alternative to Egg Albumin and/or to Methyl Cellulose

In Example 1, several mixtures were made combining native pea starch Pea Starch N-735, pea protein isolate Nutralys® F85F and mains drinking water.

In order to demonstrate the performance of the solution according to the invention, it will be compared with a yellow pea flour whose composition is as follows:

$$Moisture = 11 \%$$

$$Protein = 24 \%$$

$$Starch = 47 \%$$

As in Example 1, gels having 3 different protein contents are produced by varying the quantity of pea flour used

The solutions thus obtained are gelled using the following protocol:
The ingredients are introduced into the tank of an RVA (“Rapid Viscosity Analyzer”) viscometer
In order to produce the gel, the RVA is started with the following program:

TABLE 1

| Time (min:s) | Function | Value | |
|---|---|---|---|
| 00:00 | Temperature | 35° | C. |
| 00:00 | Speed | 960 | rpm |
| 00:10 | Speed | 160 | rpm |
| 01:00 | Temperature | 35° | C. |
| 09:00 | Temperature | 95° | C. |
| 15:00 | Temperature | 95° | C. |
| 23:00 | Temperature | 35° | C. |

| | |
|---|---|
| 33:00 | End |

Their firmness is analyzed using the following protocol:
18 g of gel is extracted and inserted into a metal capsule
The capsule is placed in a TA Shimadzu EZ-SX texturometer with a cylinder-like probe, an analysis speed of 1 mm/sec and an analysis distance of 10 mm. The measurement is performed twice.

The table below summarizes the different gels produced and the firmness values obtained:

| Protein/starch ratio (%) | 1:2 | | | |
|---|---|---|---|---|
| Gel protein concentration (%) | 2.50% | 3.00% | 4.00% | 5.00% |
| Amount of pea protein | 0.70 | 0.84 | 1.12 | 1.40 |
| Amount of pea starch | 1.37 | 1.64 | 2.19 | 2.74 |
| Drinking water | 1.96 | | | |
| Table salt | 0.1 | | | |
| Average firmness (2 values, in N) | 0.09 | 0.19 | 1.2 | 2.5 |

A straight line can thus be drawn showing the firmness of the gel based on the gel protein concentration. Finally, the slope of the line is calculated by linear regression (see [FIG. 8]).

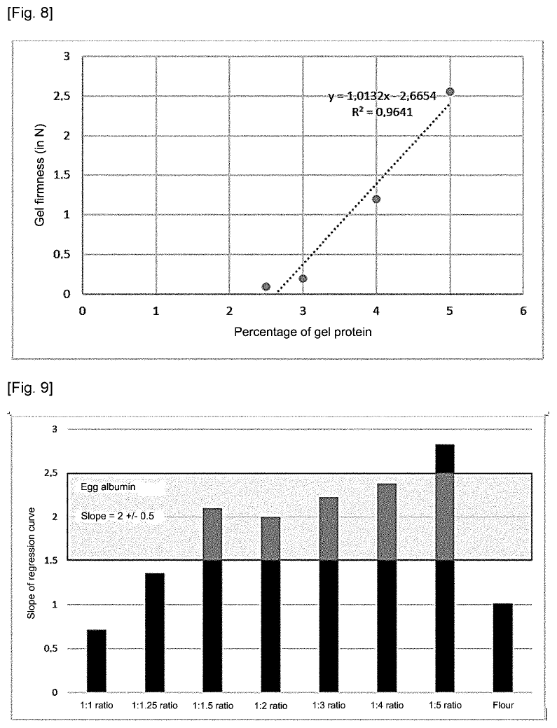

The slope obtained with pea flour is 1.0132 which is clearly far from the slope values of the mixtures according to the invention (see [FIG. 9]).

### Example 2: Impact of the Botanical Origin of the Starch

The aim of this example is to study the influence of the starch type on gel firmness.

Table 3 below shows the different compositions tested in order to assess the impact of botanical origin on the gel obtained:

TABLE 3

| Components | | Amount (in g) | | | | | |
|---|---|---|---|---|---|---|---|
| Tap water | | 620.70 | | | | | |
| Pea protein isolate | NUTRALYS F85F | 72.00 | | | | | |
| Sodium chloride | | 3.30 | | | | | |
| Native pea starch | Pea starch | 144.00 | | | | | |
| | N735 - ROQUETTE | | | | | | |
| Native wheat starch | Roquette | | 144.00 | | | | |
| Native corn starch | Roquette | | | 144.00 | | | |
| Native potato starch | Roquette | | | | 144.00 | | |
| Native tapioca starch | Roquette | | | | | 144.00 | |
| Modified pea starch | CLEARAM | | | | | | 144.0 |
| | LI1000 - | | | | | | |
| | ROQUETTE | | | | | | |

Gels are made with the mixtures described hereinbefore using the method described below:
1. Prepare the water adjusted to 5° C.
2. Place the water and the salt in the bowl of a HOTMIX mixer.
3. Start mixing at 300 rpm for 1 min.
4. Stop stirring, add the proteins and the starch, then restart mixing at 3000 rpm for 1 min.
5. Fill 50 g into a plastic container fitted with a stopper.
6. Heat at 92-98° C. for 10 min.
7. Remove the container and allow to cool to room temperature.

Firmness is measured using the methodology described in Example 1. However, it is measured twice during the cooling cycle:
After about 20 min, check that the gel temperature is between 55-60° C.
Open the container and take a 2-cm wide sample.
Analyze the hardness of the sample using the methodology described in Example 1.
After 3 hours, check that the gel temperature is 21-23° C.
Analyze the hardness of the sample using the methodology described in Example 1.

Table 4 below summarizes the different gel firmnesses obtained:

TABLE 4

| | Gel firmness | Gel firmness |
|---|---|---|
| | at 60° C. | at 20° C. |
| | (in N) | (in N) |
| Nutralys F85F + Pea starch N-735 | 44.071 | 56.026 |
| Nutralys F85F + Native wheat starch | 8.578 | 12.201 |
| Nutralys F85F + Native corn starch | 10.934 | 21.672 |
| Nutralys F85F + Native potato starch | 10.935 | 19.198 |
| Nutralys F85F + Native tapioca starch | 14.326 | 29.326 |
| Nutralys F85F + Modified pea starch | 47.051 | 52.656 |

FIG. 3 shows these values graphically.

It appears that only the use of the pea of botanical origin, whether in native or modified form, makes it possible to obtain a fairly firm gel, with a firmness greater than 30 N, both at 20° C. but also at 60° C. The resulting gel is cohesive both at low temperatures but also at cooking and consumption temperatures.

### Example 3: Application in a Veggie Burger Recipe

A number of burgers (meat substitute patties) are produced, the compositions of which are given below:

TABLE 5

| | | | | Test 3: | Test 4: | Test 5: |
|---|---|---|---|---|---|---|
| | | Test 1: | Test 2: | without | without | without |
| | | S85plus | F85F | potato | pregelatinized | pregelatinized |
| INGREDIENTS | | isolate | isolate | starch | potato starch | pea starch |
| Water | Drinking water | 50.7 | 50.7 | 50.7 | 50.7 | 50.7 |
| Textured | NUTRALYS ® T Pea- | 11 | 11 | 11 | 11 | 11 |
| protein | Fava 571L Organic | | | | | |
| | NUTRALYS ® T Pea- | 11 | 11 | 11 | 11 | 11 |
| | Fava 571S Organic | | | | | |
| Binder | PREGEFLO ® L100G - | 5.5 | 5.5 | 9.5 | 6.55 | 0 |
| | EXP Pregelatinized | | | | | |
| | pea starch | | | | | |
| | Potato starch | 8 | 8 | 0 | 9.05 | 10.75 |
| | PREGEFLOR P100 - | 2.1 | 2.1 | 6.1 | 0 | 4.85 |
| | Pregelatinized | | | | | |
| | potato starch | | | | | |
| | NUTRALYS ® F85F | 0 | 3.35 | 0 | 0 | 0 |
| | NUTRALYS ® S85+ | 3.35 | 0 | 3.35 | 3.35 | 3.35 |
| Other | Coconut fat | 5.2 | 5.2 | 5.2 | 5.2 | 5.2 |
| ingredients | Onion powder | 1 | 1 | 1 | 1 | 1 |
| | Red coloring | 1 | 1 | 1 | 1 | 1 |
| | Garlic powder | 0.5 | 0.5 | 0.5 | 0.5 | 0.5 |
| | Table salt | 0.4 | 0.4 | 0.4 | 0.4 | 0.4 |
| | Ground black pepper | 0.25 | 0.25 | 0.25 | 0.25 | 0.25 |

| | | | | | |
|---|---|---|---|---|---|
| Total | 100 | 100 | 100 | 100 | 100 |

The protocol for manufacturing different burgers is as follows:
Put coconut oil in the freezer
After solidification, cut the coconut oil into small particles (½ mm) with a chopper
Mix all the ingredients listed in the table hereinbefore together in a container, with the exception of the water, textured proteins and coloring.
Mix the water and coloring together in the bowl of a KENWOOD-like food processor.
Place NUTRALYS® T Pea-Fava 571S Organic in a KENWOOD-like bowl and stir with K-beater for 2 minutes.
Then add NUTRALYS® T Pea-Fava 571L Organic and mix again for 1 minute
Add the powder mixture made previously and mix for 2 minutes at speed 1
Add the coconut particles and mix for 1 minute at speed 1
Make patties in the shape of a steak haché (30 g)
Freeze for 2 hours then store the products in the freezer
To consume, defrost the patties and reheat in a frying pan with a little oil, over medium heat, 3 min per side

The different burgers are compared using a sensory analysis protocol described below:
16 panelists trained to taste veggie burgers are involved
They are sat in a box lit with a white light
The burgers are presented to them anonymously, using 3-digit codes to identify them.
The different burgers are presented in random order
The methods used are called “pairwise comparison” and “ranking evaluation”

The different burgers are also compared by performing a textural analysis, the protocol of which is described below:
A TA.XTplus texturometer is used
Measurements are taken 5 times to calculate the mean and standard deviation
To analyze the raw burger, the parameters are as follows
Pre-test speed 1 mm/s
Test speed 1 mm/s
Post-test speed 10 mm/s
50% deformation
To analyze the cooked burger, the parameters are as follows
Pre-test speed 2 mm/s
Test speed 10 mm/s
Post-test speed 10 mm/s
75% deformation

The purpose of comparing the results obtained with tests 1 and 2 is to demonstrate the impact of a native isolate and a slightly hydrolyzed isolate (DH=5%).

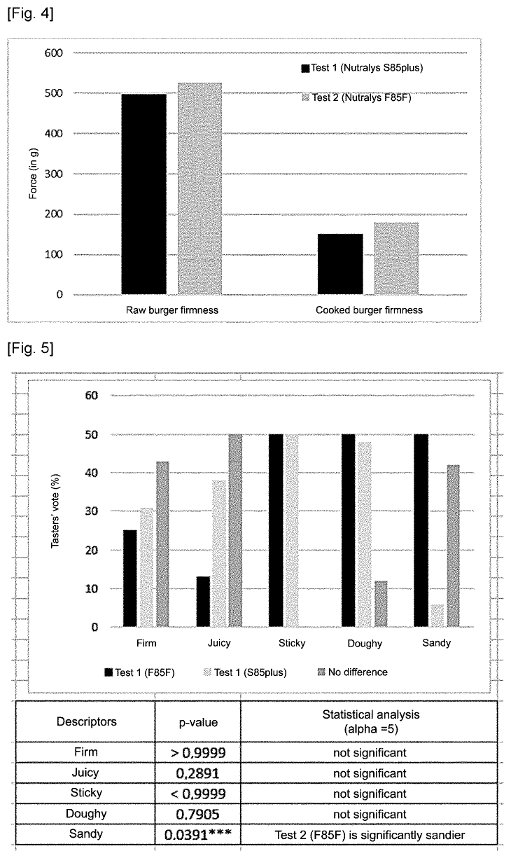

FIG. 4 thus shows that the use of a native or slightly hydrolyzed isolate has no effect on firmness.

In the sensory analysis, the results of which are shown in FIG. 5, tasters indicated which of the burgers from tests 1 and 2 was the firmest, juiciest, stickiest, doughiest and sandiest, with the option of indicating that they felt no differences between the two burgers. This analysis shows that using a slightly hydrolyzed isolate (test 2) results in a less sandy feel. It should be noted that firmness, juiciness, stickiness and doughiness are similar in all respects between tests 1 and 2 (see FIG. 5).

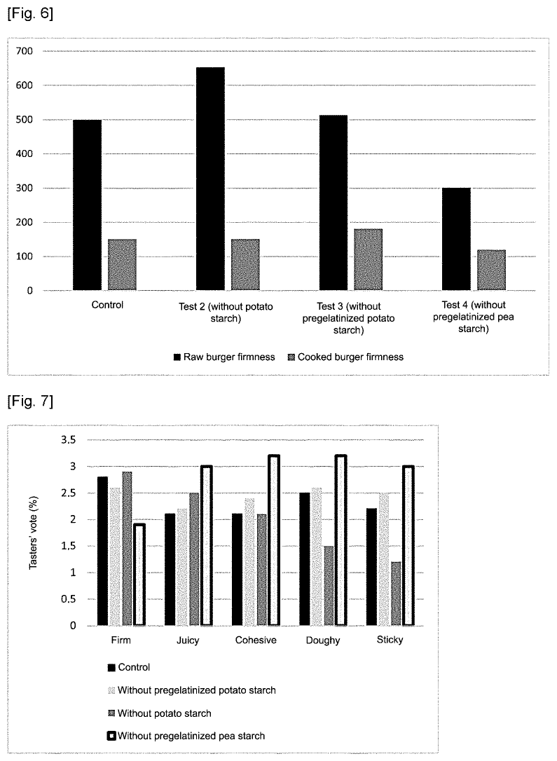

The comparison of test 3 (recipe without potato starch), test 4 (recipe without pregelatinized potato starch) and test 5 (recipe without pregelatinized pea starch) shows the impact of the presence or absence of starch in the product:
In FIG. 6, the comparative textural analysis concludes that the burger is less firm, whether raw or cooked, when the recipe does not contain pea starch compared with the control
In FIG. 7, the absence of pea starch is detected by the panel as resulting in a doughier, stickier burger, indicating that its presence is important for good taste.

### Example 3 Bis: Application of Pea Flour as a Binder in a Veggie Burger Recipe

Two burgers (meat substitute patties) are produced, the compositions of which are given below:

| | | Test 6: | |
|---|---|---|---|
| | | Control | |
| | | Composition | |
| | | according to | |
| | | the invention | |
| | | with potato | Test 7: |
| INGREDIENTS | | starch | Pea flour |
| Water | Drinking water | 50.7 | 50.7 |
| Textured | NUTRALYS ® T Pea-Fava | 11 | 11 |
| | 571L Organic | | |
| protein | NUTRALYS ® T Pea-Fava | 11 | 11 |
| | 571S Organic | | |
| Binder | PREGEFLO ® L100G - EXP | 5.5 | 0 |
| | pregelatinized pea starch | | |
| | Potato starch | 8 | 0 |
| | PREGEFLO ® P100 - | 2.1 | 0 |
| | Pregelatinized potato starch | | |
| | Pea flour | 0 | 18.95 |
| | NUTRALYS ® S85+ | 3.35 | 0 |
| Other | Coconut fat | 5.2 | 5.2 |
| ingredients | Onion powder | 1 | 1 |
| | Red coloring | 1 | 1 |
| | Garlic powder | 0.5 | 0.5 |
| | Table salt | 0.4 | 0.4 |
| | Ground black pepper | 0.25 | 0.25 |

| | | |
|---|---|---|
| Total | 100 | 100 |

The protocol for manufacturing two burgers is as follows:
Put coconut oil in the freezer
After solidification, cut the coconut oil into small particles (½ mm) with a chopper
Mix all the ingredients listed in the table hereinbefore together in a container, with the exception of the water, textured proteins and coloring.
Mix the water and coloring together in the bowl of a KENWOOD-like food processor.
Place NUTRALYS® T Pea-Fava 571S Organic in a KENWOOD-like bowl and stir with K-beater for 2 minutes.
Then add NUTRALYS® T Pea-Fava 571L Organic and mix again for 1 minute
Add the powder mixture made previously and mix for 2 minutes at speed 1
Add the coconut particles and mix for 1 minute at speed 1
Make patties in the shape of a steak haché (30 g)
Freeze for 2 hours then store the products in the freezer
To consume, defrost the patties and reheat in a frying pan with a little oil, over medium heat, 3 min per side

The two burgers are compared using a textural analysis protocol described below:
A TA.XTplus texturometer is used
Measurements are taken 5 times to calculate the mean and standard deviation
To analyze the raw burger, the parameters are as follows
Pre-test speed 1 mm/s
Test speed 1 mm/s
Post-test speed 10 mm/s
50% deformation
To analyze the cooked burger, the parameters are as follows
Pre-test speed 2 mm/s
Test speed 10 mm/s
Post-test speed 10 mm/s
75% deformation

The purpose of comparing the results obtained with tests 6 and 7 is to demonstrate the performance of the mixture according to the invention compared to a pea flour having the same protein/starch ratio.

During the sensory analysis,

The results of the structural analysis are as follows:

| | Firmness of raw | Firmness of burgers |
|---|---|---|
| | burgers (in g) | after cooking (in g) |
| Example 6 - Control | 494 | 153 |
| Example 7 - Pea flour | 223 | 191 |

On raw burgers, there are significant differences in firmness. With its low firmness (divided by 2 compared with the control), test 7 with pea flour is sticky and tender, making burger shaping more difficult. This results in difficulties during the manufacturing process, particularly at the shaping stage.

The composition according to the invention therefore provides a competitive advantage, enabling the raw burger to be shaped optimally.

The burgers are also compared using a sensory analysis protocol described below:
11 panelists trained to taste veggie burgers are involved
They are sat in a box lit with a white light
The burgers are stored at −18° C., defrosted and pan-fried for 10 minutes
The burgers are presented to them anonymously, using 3-digit codes to identify them.
The burgers are presented in random order
The methods used are called “pairwise comparison” and “ranking evaluation”

The results obtained comparing the control and test 7 with pea flour are as follows:

| | Control (invention) | Test 7 (flour) |
|---|---|---|
| Firmness | 5 | 3 |
| Cohesion | 8 | 3 |
| Doughy | 5 | 6 |
| Sticky | 5 | 6 |

It is clear to see that the burger obtained with the composition according to the invention (control) is judged to be more cohesive than with pea flour (test 7). It is also possible to discern a tendency towards greater firmness. At the tasting, the panelists all judged that the burger in test 7 had a strong veggie taste unlike the control.

1. A composition comprising a mixture of vegetable proteins, potentially leguminous plants, and pea starch, said mixture being wherein the ratio of vegetable proteins to pea starch is 1:1.5 to 1:4, preferentially 1:1.5 to 1:2, even more preferentially 1:1.5 to 1:1.7, and optionally potato starch in a potato starch/pea starch ratio ranging from 1.5 to 2.0, preferentially 1.6 to 1.9, preferentially 1.7 to 1.9.

2. The composition according to claim 1, wherein the starch content in the composition expressed as a percentage of total solids is between 60% and 80%, preferentially between 60% and 67%, even more preferentially between 60% and 63%.

3. The composition according to claim 1 wherein it consists of a mixture of vegetable proteins, preferentially leguminous plants, and pea starch, wherein the ratio by weight of leguminous plant proteins to pea starch is from 1:1.5 to 1:4, preferentially 1:1.5 to 1:2, even more preferentially 1:1.5 to 1:1.7.

4. The composition according to claim 1 wherein the leguminous plant proteins are selected from pea, faba bean, soybean or mung bean proteins.

5. The composition according to claim 1 wherein the leguminous proteins are pea proteins.

6. The composition according to claim 1 wherein the pea proteins have a degree of hydrolysis ranging from 0% to 15%, preferentially 2% to 13%, preferentially 3% to 10%, even more preferentially 4% to 8%.

7. The composition according to claim 1 wherein the pea starch is pregelatinized or native.

8. A method for obtaining a composition according to claim 1 wherein it comprises the following steps:
a. Providing vegetable proteins, preferentially from leguminous plants, and pea starch,
b. Optionally providing potato starch,
c. Mixing the compounds obtained in step a) and optionally in step b), and
d. Optionally shaping the mixture obtained in step c).

9. The method according to claim 8 wherein the composition obtained in step b) or in step c) is added directly after production in combination with other ingredients in order to produce a meat substitute.

10. Use of the composition according to claim 1 or obtained by:
a. Providing vegetable proteins, preferentially from leguminous plants, and pea starch,
b. Optionally providing potato starch,
c. Mixing the compounds obtained in step a) and optionally in step b), and
d. Optionally shaping the mixture obtained in step c);
wherein the composition obtained in step b) or in step c) is added directly after production in combination with other ingredients in order to produce a meat substitute in the human food, animal feed, nutraceutical and pharmaceutical industries.

11. Use according to claim 10 wherein the industrial field is the bakery-pastry industry.

12. Use according to claim 10 wherein the industrial field is the production of sauces, soups, meat substitutes or fish substitutes.
